(19) United States
(12) Patent Application Publication
(10) Pub. No.: US 2014/0028096 A1
(43) Pub. Date: Jan. 30, 2014

(54) RECTIFIER CIRCUIT AND ELECTRONIC DEVICE USING SAME

(71) Applicant: HON HAI PRECISION INDUSTRY CO., LTD., New Taipei (TW)

(72) Inventors: KAI-FU CHEN, New Taipei (TW); CHIEN-SEN HSU, New Taipei (TW); CHUANG-WEI TSENG, New Taipei (TW); CHE-HSUN CHEN, New Taipei (TW)

(73) Assignee: HON HAI PRECISION INDUSTRY CO., LTD., New Taipei (TW)

(21) Appl. No.: 13/949,161

(22) Filed: Jul. 23, 2013

(30) Foreign Application Priority Data
Jul. 24, 2012 (TW) 101126546

(51) Int. Cl. H02M 7/217

(52) U.S. Cl. CPC H02M 7/217
USPC 307/31

(57) ABSTRACT

A rectifier circuit includes a three-phase AC power supply and a first rectifier unit. The three-phase AC power supply comprises a first AC voltage output terminal and a common terminal The three-phase AC power supply generates a first, a second, and a third AC voltage and outputs the AC voltages through output terminals and the common terminal The common terminal is grounded. The first rectifier unit converts each of the AC voltages into a first, second, and third DC voltage for independently powering separate loads. The first rectifier unit includes a grounded terminal connected to the common terminal to ground via a same conductive wire.

### BACKGROUND

1. Technical Field

The present disclosure relates to voltage rectifying technologies, and more particularly to a rectifier circuit having a power factor correction function and an electronic device using the same.

2. Description of Related Art

FIG. 1 shows a circuit diagram of a typical rectifier circuit 100 of prior art. The rectifier circuit 100 may provide a direct current (DC) voltage as a driving voltage to a load 17. The rectifier circuit 100 includes a bridge rectifier 13 and a filter capacitor 14. The bridge rectifier 13 receives an alternating current (AC) voltage via a first AC voltage input terminal 11 and a second AC voltage input terminal 12, converts the AC voltage into a DC voltage, and outputs the DC voltage to the filter capacitor 14 via a first DC voltage output terminal 15 and a second DC voltage output terminal 16. The second AC voltage input terminal 12 and the second DC voltage output terminal 16 are grounded. However, in use of the bridge rectifier 13, two negative terminals, such as terminals 12 and 131, have to connect different grounding pins. In addition, when the rectifier circuit 100 is employed by a circuit having a power factor correction function, a transformer is usually used. However, the circuit may require a more space to place the transformer. What is needed is to provide a means that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is a circuit diagram of a typical rectifier circuit of prior art.

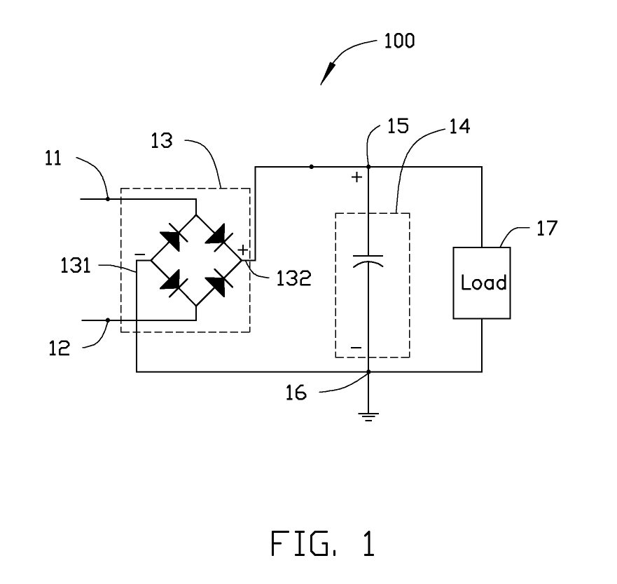

FIG. 2 is a circuit diagram of a rectifier circuit according to one embodiment of present disclosure.

FIG. 3 is a circuit diagram of a rectifier circuit according to another embodiment of present disclosure.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

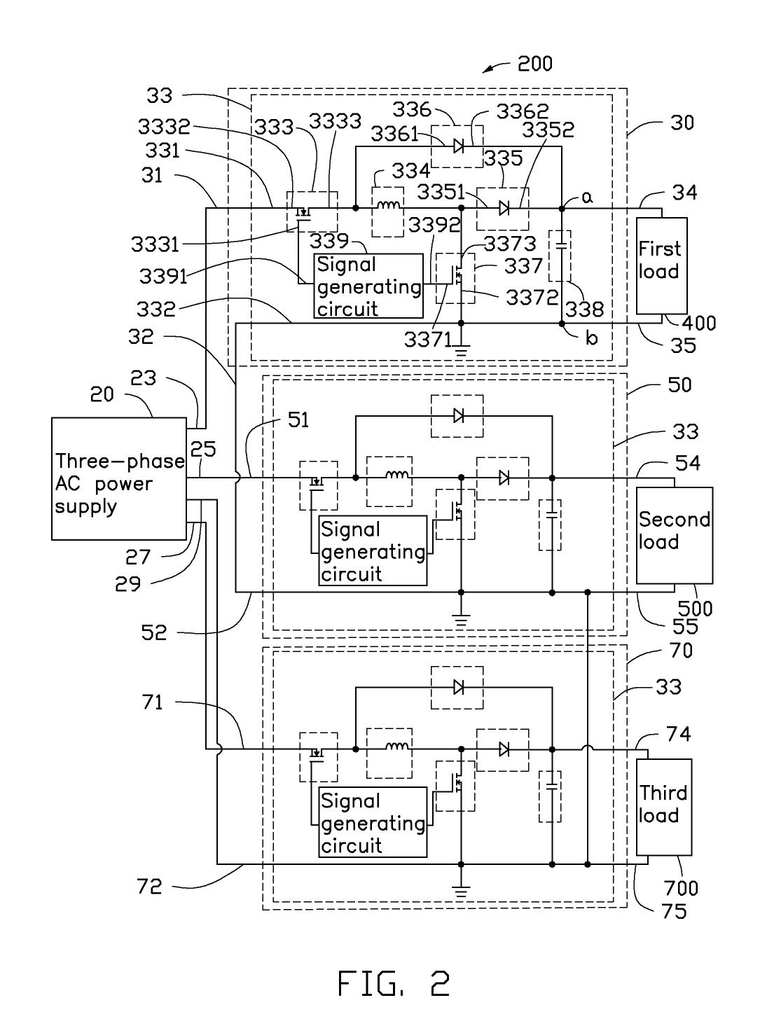

FIG. 2 is a circuit diagram of a rectifier circuit according to one embodiment of present disclosure. The rectifier circuit 200 may be adapted to provide driving voltages to a first load 400, a second load 500 and a third load 700. For example, the first load 400, the second load 500 and the third load 700 may be LEDs. The rectifier circuit 200 includes a three-phase AC power supply 20, a first rectifier unit 30, a second rectifier unit 50, and a third rectifier unit 70.

The three-phase AC power supply 20 includes a first AC voltage output terminal 23, a second AC voltage output terminal 25, a third AC voltage 27 and a common terminal 29. The common terminal 29 is grounded. The three-phase AC power supply 20 generates a first AC voltage, a second AC voltage and a third AC voltage. The first AC voltage, the second AC voltage and the third AC voltage have a same frequency. The first AC voltage and the second AC voltage, the second AC voltage and the third AC voltage, the third AC voltage and the first AC voltage have a same phase difference. The phase difference is sixty degrees, in one example. The first AC voltage is output via the first AC voltage output terminal 23 and the common terminal 29. The second AC voltage is output via the second AC voltage output terminal 25 and the common terminal 29. The third AC voltage is output via the third AC output terminal 27 and the common terminal 29. Each of the first AC voltage, the second AC voltage and the third AC voltage is a periodical and sinusoidal waveform. The sinusoidal waveform includes a positive period and a negative period. The voltage value of the AC voltage is greater than zero in the positive period and less than zero in the negative period.

The first rectifier unit 30 receives the first AC voltage and converts the first AC voltage into a first DC voltage. The first DC voltage serves as a driving voltage of the first load 400. The second rectifier unit 50 receives the second AC voltage and converts the second AC voltage into a second DC voltage. The second DC voltage serves as a driving voltage of the second load 500. The third rectifier unit 70 receives the third AC voltage and converts the third AC voltage into a third DC voltage. The third DC voltage serves as a driving voltage of the third load 700.

The first rectifier unit 30 includes a first receiving terminal 31, a second receiving terminal 32, a rectifier sub-unit 33, a first output terminal 34 and a second output terminal 35. The first receiving terminal 31 and the second receiving terminal 32 are electronically coupled to the first AC voltage output terminal 23 and the common terminal 29 respectively. The second rectifier unit 50 and the third rectifier unit 70 include a rectifier sub-unit 33. The rectifier sub-unit 33 of the second rectifier unit 50 and the rectifier sub-unit 33 of the third rectifier unit 70 have same electronic components and connections with the rectifier sub-unit 33 of the first rectifier unit 30. Hereafter, the rectifier sub-unit 33 of the first rectifier unit 30 will be described.

The rectifier sub-unit 33 of the first rectifier unit 30 includes a first voltage input terminal 331, a second voltage input terminal 332, a first switch 333, an energy storing circuit 334, a first unidirectional circuit 335, a second unidirectional circuit 336, a second switch 337, a smoothing circuit 338, a signal generating circuit 339, a first DC voltage output terminal “a” and a second DC voltage output terminal “b.”

The first voltage input terminal 331 and the second voltage input terminal 332 are electronically coupled to the first receiving terminal 31 and the second receiving terminal 32.

The signal generating circuit 339 includes a first terminal 3391 and a second terminal 3392. The signal generating circuit 339 generates a first control signal and a second control signal, outputs the first control signal via the first terminal 3391, and outputs the second control signal via the second terminal 3392. The first control signal and the second control signal are pulse width modulation (PWM) signals.

The first switch 333 includes a first control terminal 3331, a second control terminal 3332 and a third control terminal 3333. The first control terminal 3331 is electronically coupled to the first terminal 3391. The first switch 333 receives the first control signal being output from the first terminal 3391 and switches on or switches off under the control of the first control signal. In detail, the first control terminal 3331 controls the second control terminal 3332 and the third control terminal 3333 to turn on or turn off under the control of the first control signal. When the second control terminal 3332 and the third control terminal 3333 are turned on, the first switch 333 switches on. When the second control terminal 3332 and the third control terminal 3333 are turned off, the first switch 333 switches off. In one embodiment, the first switch 333 is a n-channel metal oxide semiconductor (NMOS) field effect transistor (FET). The first control terminal 3331 is a grid of the NMOSFET, the second control terminal 3332 is a drain of the NMOSFET, and the third control terminal 3333 is a source of the NMOSFET.

The second switch 337 includes a fourth control terminal 3371, a fifth control terminal 3372 and a sixth control terminal 3373. The second switch 337 receives the second control signal being output from the second terminal 3392 and switches on or switches off under the control of the second control signal. In detail, the fourth control terminal turns on or turns off the fifth control terminal 3372 and the six control terminal 3373 under the control of the second control signal. When the fifth control terminal 3372 and the sixth control terminal 3373 are turned on, the second switch 337 switches off. When the fifth control terminal 3372 and the sixth control terminal 3373 are turned off, the second switch 337 switches off. In one embodiment, the second switch 337 is an NMOS FET. The fourth control terminal 3371 is a grid of the NMOS FET, the fifth control terminal 3372 is a drain of the NMOS FET, and the sixth control terminal 3373 is a source of the NMOS FET.

The first unidirectional circuit 335 includes an anode 3351 and a cathode 3352. The anode 3351 is electrically coupled to a node between the energy storing circuit 334 and the sixth control terminal 3373 of the second switch 337. The cathode 3352 is electrically coupled to the first DC voltage output terminal “a.” The first unidirectional circuit 335 turns on when the voltage value of the anode 3351 is greater than voltage value of the cathode 3352, and turns off when the voltage value of the anode 3352 is less than voltage value of the cathode 3352. In an embodiment, the first unidirectional circuit 335 is a diode. The anode 3351 is an anode of the diode, and the cathode 3352 is a cathode of the diode.

The second unidirectional circuit 336 includes an anode terminal 3361 and a cathode terminal 3362. The anode 3361 is electrically coupled to a node formed between the third control terminal 3333 of the first switch 333 and the energy storing circuit 334. The cathode 3362 is electronically coupled to the first DC voltage output terminal “a.” The second unidirectional circuit 336 turns on when the voltage value of the anode 3361 is greater than that of the cathode 3362, and turns off when the voltage value of the anode 3362 is less than that of the cathode 3362. In an embodiment, the second unidirectional circuit 336 is a diode. The anode terminal 3361 is an anode of the diode, and the cathode terminal 3362 is a cathode of the diode.

The energy storing circuit 334, such as a inductor, is electronically coupled between the third control terminal 3333 and the sixth control terminal 3373. The energy storing circuit 334 works with the first unidirectional circuit 335 and the second unidirectional circuit 336 in converting the first AC voltage into the second DC voltage

The smoothing circuit 338 is electronically coupled between the first DC voltage output terminal “a” and the second DC voltage output terminal “b.” The smoothing circuit 338 smoothes the first DC voltage. In one embodiment, the smoothing circuit 338 is a smoothing capacitor.

The conversion of the first AC voltage into the first DC voltage is described below. In the positive period of the first AC voltage, the first switch 333 is switched on under the control of the signal generating circuit 339. The second switch 337 is switched on in a first sub-period of the positive period and switched off in a second sub-period of the positive period. When both of the first switch 333 and the second switch 337 are switched on in the first sub-period of the positive period, the energy storing circuit 334 stores energy distributed by the first AC voltage. When the first switch 333 is switched on and the second switch 337 is switched off in the second sub-period of the positive period, the energy storing circuit 334 is discharged to the first DC voltage output terminal “a” via the first unidirectional circuit 335.

In the negative period of the first AC voltage, the second switch 337 is switched on under the control of the signal generating circuit 339. The first switch 333 is switched on in a first sub-period of the negative period, and is switched off in a second sub-period of the negative period. When both of the first switch 333 and the second switch 337 are switched on in the first sub-period of the negative period, the energy storing circuit 334 stores energy distributed by the first AC voltage. When the first switch 333 is switched off and the second switch 337 is switched on in the second sub-period of the negative period, the energy storing circuit 334 is discharged to the first DC voltage output terminal “a” via the second unidirectional circuit 336.

The second rectifier unit 50 includes a third receiving terminal 51, a fourth receiving terminal 52, a rectifier sub-unit 33, a third output terminal 54 and a fourth output terminal 55. The third receiving terminal 51 is electronically coupled to the second AC voltage output terminal 25. The fourth receiving terminal 52 is electronically coupled to the common terminal 29. The rectifier sub-unit 33 of the second rectifier unit 50 receives the second AC voltage via the third receiving terminal 51 and the fourth receiving terminal 52, converts the second AC voltage into the second DC voltage, and outputs the second DC voltage via the third output terminal 54 and the fourth output terminal 55.

The third rectifier unit 70 includes a fifth receiving terminal 71, a sixth receiving terminal 72, a rectifier sub-unit 33, a fifth output terminal 74 and a sixth output terminal 75. The fifth receiving terminal 71 is electronically coupled to third AC voltage output terminal 27. The sixth receiving terminal 72 is electronically coupled to the common terminal 29. The rectifier sub-unit 33 of the third rectifier unit 70 receives the third AC voltage via the fifth receiving terminal 71 and the sixth receiving terminal 72, converts the third AC voltage into the third DC voltage, and outputs the third DC voltage via the fifth output terminal 74 and the sixth output terminal 75.

In this embodiment, the common terminal 29, the second output terminal 35 of the first rectifier 30, the fourth output terminal 55 of the second rectifier 50, and the sixth output terminal 75 of the third rectifier 70 may be electronically connected to each other by using a common grounded wire. This reduces the number of conductive wires being grounded. The first DC voltage, the second DC voltage and the third DC voltage converted by the rectifier circuit 200 can independently drive their separate loads, and a transformer is not needed in the rectifier circuit 200.

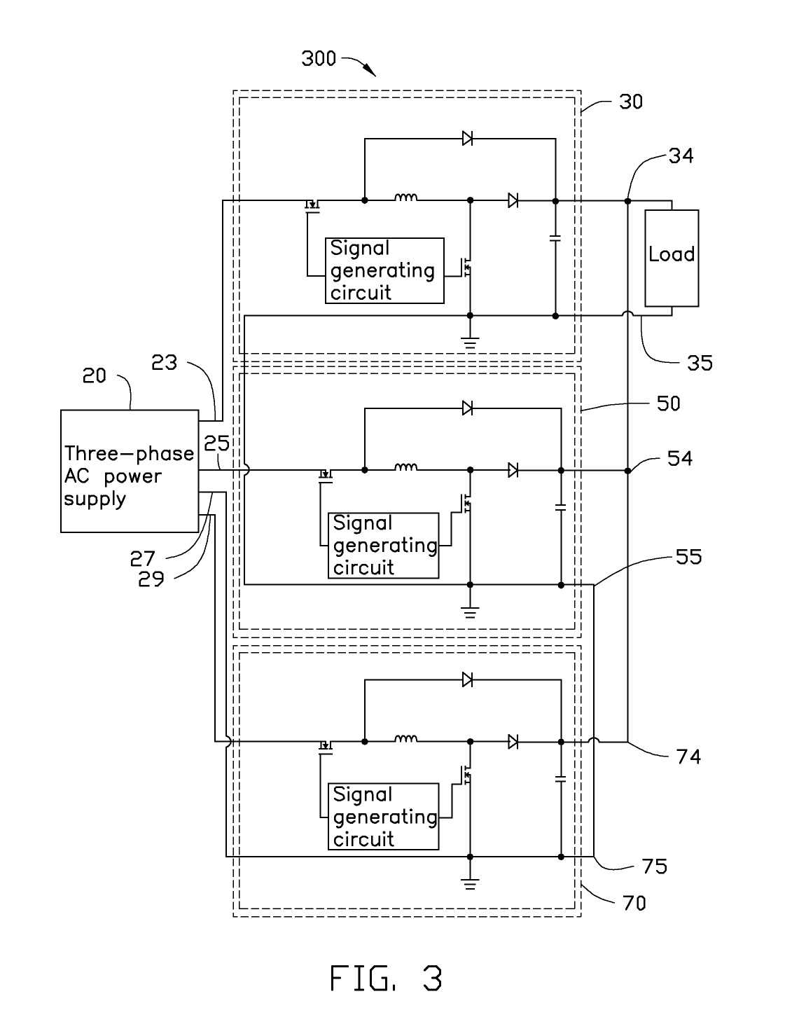

FIG. 3 is a circuit diagram of a rectifier circuit 300 according to another embodiment of present disclosure. The rectifier circuit 300 is similar to the rectifier circuit 200. The difference between the rectifier circuit 300 and the rectifier circuit 200 is described hereafter. The output terminals of the first rectifier 30, the second rectifier 50 and the third rectifier 70 are in parallel. That is, the first output terminal 34, the third output terminal 54 and the fifth output terminal 74 are electronically coupled to each other, the second output terminal 35, the fourth output terminal 55 and the sixth output terminal 75 are electronically coupled to each other, and serve as two output terminals of the rectifier circuit 300.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A rectifier circuit, comprising:
a three-phase AC power supply generating a first AC voltage; and
a first rectifier unit converting the first AC voltage into a first DC voltage for powering a first load;
wherein the three-phase AC power supply comprises a first AC voltage output terminal and a common terminal for outputting the first AC voltage, the first rectifier unit comprises a ground terminal, the common terminal is electronically coupled the ground terminal of the first rectifier unit, and the common terminal and the ground terminal of the first rectifier unit are connected to ground via a same conductive wire.

2. The rectifier circuit according to claim 1, wherein the first rectifier unit comprises a rectifier sub-unit; the rectifier sub-unit comprises a first receiving terminal, a second receiving terminal, a first switch, a second switch, an energy storing circuit, a signal generating circuit, a first unidirectional circuit, a first DC voltage output terminal and a second voltage output terminal; the first receiving terminal and the second receiving terminal receive the first AC voltage; the signal generating circuit generates a first control signal and a second control signal; the first switch is switched on in a positive period of the first AC voltage, the first switch is switched on in a first sub-period of a negative period of the first AC voltage, and is switched off in a second sub-period of the negative period of the first AC voltage under the control of the first control signal; the second switch is switched on in a first sub-period of the positive period of the first AC voltage, the second switch is switched off in a second sub-period of the positive period, and is switched on in the negative period of the first AC voltage under the control of the second control signal; the energy storing circuit stores energy by charging of the first AC voltage, and in the second sub-period of the positive period, the energy storing circuit discharges to the first load via the first unidirectional circuit.

3. The rectifier circuit according to claim 2, wherein in the first sub-period of the positive period, the energy storing circuit stores energy by charging of the first AC voltage, and in the second sub-period of the negative period, the energy storing circuit discharges to the first load via the second unidirectional circuit.

4. The rectifier circuit according to claim 2, wherein the first switch comprises a first control terminal, a second control terminal and a third control terminal, the first control terminal receives the first control signal, the second control terminal and the third control terminal are switched on or switched off under the control of the first control signal, the second control terminal is electronically coupled to the first receiving terminal, and the third control terminal is electronically coupled to the energy storing circuit.

5. The rectifier circuit according to claim 4, wherein the first switch is a n-channel metal oxide semiconductor (NMOS) field effect transistor (FET), the first control terminal is a grid of the NMOSFET, the second control terminal is a drain of the NMOSFET, and the third control terminal is a source of the NMOSFET.

6. The rectifier circuit according to claim 2, wherein the second switch comprises a fourth control terminal, a fifth control terminal and a sixth control terminal, the fourth control terminal receives the second control signal, controls the fifth control terminal and the sixth control terminal to switch on or switch off under the control of the second control, the fifth control terminal is grounded, the sixth control terminal is electronically coupled to a node between the energy storing circuit and the second unidirectional circuit.

7. The rectifier circuit according to claim 6, wherein the second switch is n-channel metal oxide semiconductor (NMOS) field effect transistor (FET), the fourth control terminal is a grid of the NMOSFET, the fifth control terminal is a drain of the NMOSFET, and the sixth control terminal is a source of the NMOSFET.

8. The rectifier circuit according to claim 2, wherein the first unidirectional circuit is a diode, the diode comprises an anode and a cathode, the anode is electronically coupled to a node between the energy storing circuit and the second switch, and the cathode is electrically coupled to the first DC output terminal.

9. The rectifier circuit according to claim 2, wherein the second unidirectional circuit is a diode, the diode comprises a anode and a cathode, the anode is electronically coupled a node between the first switch and the energy storing circuit, and the cathode is electrically coupled to the first DC output terminal.

10. The rectifier circuit according to claim 2, wherein the rectifier circuit further comprises a smoothing circuit and the smoothing circuit is electronically couple between the first DC voltage output terminal and the second DC voltage output terminal to smooth the first DC voltage.

11. The rectifier circuit according to claim 10, wherein the smoothing circuit is a capacitor.

12. The rectifier circuit according to claim 2, wherein the first control signal and the second control signal are pulse with modulation (PWM) signals.

13. The rectifier circuit according to claim 2, wherein the energy storing circuit is an inductor.

14. The rectifier circuit according to claim 1, wherein the three-phase AC power supply further generates a second AC voltage and a third AC voltage, the rectifier circuit further comprises a second rectifier unit and the third rectifier unit, the second rectifier unit converts the second AC voltage into a second DC voltage for powering a second load, the third rectifier unit converts the third AC voltage into a third DC voltage, each of the second rectifier unit and the third rectifier unit comprises a ground terminal, the ground terminal of the second rectifier unit and the ground terminal of the third rectifier unit are electronically coupled to the ground terminal of the first rectifier unit through the conductive wire.

15. A rectifier circuit, comprising:
a three-phase AC power supply generating a first AC voltage, a second AC voltage and a third AC voltage;
a first rectifier unit converting the first AC voltage into a first DC voltage;
a second rectifier unit converting the second AC voltage into a second DC voltage;
a third rectifier unit converting the third AC voltage into a third DC voltage;
wherein the three-phase AC power supply comprises a first AC voltage output terminal, a second AC voltage output terminal, a third AC voltage output terminal and a common terminal, the first rectifier unit receives the first AC voltage via the first AC voltage output terminal and the common terminal, and outputs the first DC voltage via a first output terminal and a second output terminal; the second rectifier unit receives the second AC voltage via the second voltage output terminal and the common terminal, and outputs the second DC voltage via the first output terminal and the second output terminal; the third rectifier unit receives the third AC voltage via the third voltage output terminal and the common terminal, and outputs the third DC voltage via the first output terminal and the second output terminal; the common terminal and the second output terminal are grounded via a same conductive wire.

16. An electronic device comprising:
a first load;
a three-phase AC voltage power generating a first AC voltage;
a first rectifier unit converting the first AC voltage into a first DC voltage for powering the first load;
wherein the three-phase AC power supply comprises a first AC voltage output terminal and a common terminal for outputting the first AC voltage, the first rectifier unit comprises a ground terminal, the common terminal is electronically coupled the ground terminal, and the common terminal and the ground terminal of the first rectifier unit is connected to ground via a same conductive wire.

17. The electronic device according to claim 16, wherein the first rectifier unit comprises a rectifier sub-unit, the rectifier sub-unit comprises a first receiving terminal, a second receiving terminal, a first switch, a second switch, an energy storing circuit, a signal generating circuit, a first unidirectional circuit, a second unidirectional circuit, a first DC voltage output terminal and a second voltage output terminal; the first receiving terminal and the second receiving terminal receives the first AC voltage; the signal generating circuit generates a first control signal and a second control signal; the first switch is switched on in a positive period of the first AC voltage, the first switch is switched on in a first sub-period of a negative period of the first AC voltage, and is switched off in a second sub-period of a negative period of the first AC voltage under the control of the first control signal; the second switch is switched on in a first sub-period of the positive period of the first AC voltage, the second switch is switched off in a second sub-period of the positive period, and is switched on in the negative period of the first AC voltage under the control of the second control signal; in the first sub-period of the positive period, the energy storing circuit stores energy by charging of the first AC voltage; in the second sub-period of the positive period, the energy storing circuit discharges to the first load via the first unidirectional circuit; in the first sub-period of the positive period, the energy storing circuit stores energy by charging of the first AC voltage; in the second sub-period of the negative period, the energy storing circuit discharge to the first load via the second unidirectional circuit.

18. The electronic device according to claim 17, wherein the first switch comprises a first control terminal, a second control terminal and a third control terminal, the first control terminal receives the first control signal, the second control terminal and the third control terminal are switched on or switched off under the control of the first control signal; the second control terminal is electronically coupled to the first receiving terminal, the third terminal is electronically coupled to the energy.

19. The electronic device according to claim 18, wherein the first switch is a n-channel metal oxide semiconductor (NMOS) field effect transistor (FET), the first control terminal is a grid of the NMOSFET, the second control terminal is a drain of the NMOSFET, and the third control terminal is a source of the NMOSFET; the second switch is n-channel metal oxide semiconductor (NMOS) field effect transistor (FET), the fourth control terminal is a grid of the NMOSFET, the fifth control terminal is a drain of the NMOSFET, and the sixth control terminal is a source of the NMOSFET.

20. The electronic device according to claim 17, wherein the rectifier circuit further comprises a smoothing circuit, the smoothing circuit is electronically coupled between the first DC voltage output terminal and the second DC voltage output terminal, the smoothing circuit smoothes the first DC voltage.
